(19) United States
(12) Patent Application Publication
(10) Pub. No.: US 2025/0194785 A1
(43) Pub. Date: Jun. 19, 2025

(54) ORAL CARE DEVICE

(71) Applicant: GUANGZHOU STARS PULSE CO.,LTD., GUANGZHOU (CN)

(72) Inventor: SHENGBIN WU, GUANGZHOU (CN)

(21) Appl. No.: 18/927,076

(22) Filed: Oct. 25, 2024

(30) Foreign Application Priority Data
Dec. 15, 2023 (CN) 202323448534.4
Dec. 15, 2023 (CN) 202323448594.6

(51) Int. Cl. A46B 15/00; A46B 5/00; A46B 13/02; A61C 17/34

(52) U.S. Cl. CPC A46B 15/0044; A46B 5/00; A46B 13/023; A46B 15/0004; A61C 17/3481

(57) ABSTRACT

An oral care device include a first portion, a second portion, and a communication assembly. The first portion is metallic. The second portion is non-metallic and is connected to the first portion. The communication assembly is disposed inside the first portion. The communication assembly includes a signal transceiver. The signal transceiver is disposed corresponding to the second portion. The signal transceiver is configured to send signals to an exterior of the oral care device and/or to receive signals from the exterior of the oral care device. The signals sent by the signal transceiver and/or the signals received by the signal transceiver are allowed to pass through the second portion.

### TECHNICAL FIELD

The present disclosure relates to the field of oral cleaning, and in particular to an oral care device.

### BACKGROUND

An oral care device is an electric device that is equipped with a motor having a high vibration speed to drive a brush head thereof to rotate or vibrate to clean teeth. According to user demands, an antenna, which is configured to send signals and/or receive signals, is disposed in the oral care device to send operation information to a control terminal or a cloud; or to receive commands sent from the control terminal or the cloud. However, for the antennae disposed inside the oral care device, a range of signal sending and/or receiving is easily obscured by a metal shell of the oral care device, resulting in poor signal strength and poor signal quality.

### SUMMARY OF THE DISCLOSURE

The present disclosure provides an oral care device to solve the technical problem that strength and quality of signals sent from an interior of the oral care device are poor.

The present disclosure provides an oral care device including a first portion, a second portion, and a communication assembly. The first portion is metallic. The second portion is non-metallic and is connected to the first portion. The communication assembly is disposed inside the first portion. The communication assembly includes a signal transceiver, the signal transceiver is disposed corresponding to the second portion, the signal transceiver is configured to send signals to an exterior of the oral care device and/or to receive signals from the exterior of the oral care device. The signals sent by the signal transceiver and/or the signals received by the signal transceiver are allowed to pass through the second portion.

According to the present disclosure, the signal transceiver and the second portion are disposed corresponding to each other, so that the first portion that is metallic is prevented from affecting a signal transceiving function of the antenna. The sent by the signal transceiver and/or the signals received by the signal transceiver are allowed to pass through the second portion, so that quality of the signal transmission and strength of the signals are ensured. The corresponding arrangement between the signal transceiver and the second portion further ensures that at least a portion of a signal transceiving portion of the signal transceiver is located within a range where the second portion is located.

Additional aspects and advantages of the embodiments of the present disclosure will be partly illustrated in the following description and become apparent from the following description, or will be learnt through practice of the embodiments of the present disclosure.

### BRIEF DESCRIPTION OF THE DRAWINGS

FIG. 1 is a perspective schematic diagram of an oral care device according to some embodiments of the present disclosure.

FIG. 2 is a perspective schematic diagram of the oral care device according to some other embodiments of the present disclosure.

FIG. 3 is an exploded schematic diagram of the oral care device shown in FIG. 1.

FIG. 4 is an exploded schematic diagram of portions of the oral care device shown in FIG. 1.

FIG. 5 is another exploded schematic diagram of the oral care device shown in FIG. 1.

FIG. 6 is a cross-sectional view of the oral care device shown in FIG. 1.

FIG. 7 is a perspective schematic diagram of the oral care device according to some embodiments of the present disclosure.

FIG. 8 is an exploded schematic diagram of portions of the oral care device shown in FIG. 7.

FIG. 9 is an exploded schematic diagram of portions of the oral care device shown in FIG. 7.

FIG. 10 is an exploded schematic diagram of portions of the oral care device according to some other embodiments of the present disclosure.

### REFERENCE NUMERALS IN THE DRAWINGS

100—oral care device; A—center axis; X—first direction; Y—second direction; D1—first preset distance; D2—second preset distance; D3—third preset distance; H0—total length; H1—distance between the signaling transceiver and the top of the hand-held shell; H2—distance between the signaling portion and the bottom of the hand-held shell; 10—hand-held shell; 101—receiving cavity; 103—through hole; 11—hand-held portion; 111—top; 113—bottom; 115—first side; 117—second side; 119—opening; 13—bottom cover; 131—blocking portion; 133—fastening portion; 20—panel; 21—pressing portion; 23—light-transmitting portion; 201—first region; 203—second region; 30—communication assembly; 31—signal transceiver; 33—matching circuit; 35—main chip; 37—second circuit board; 39—conductive piece; 40—first circuit board; 41—first end; 43—second end; 45—protruding portion; 50—functional element; 51—button; 53—indicator; 55—display; 60—movement assembly; 61—mating portion; 63—wiring hole; 65—wire groove; 70—liner; 71—connection portion; 73—support plate.

### DETAILED DESCRIPTION

Embodiments of the present disclosure are described in detail below, and examples of the embodiments are shown in the accompanying drawings. Same or similar reference numerals denote same or similar elements or elements having same or similar functions.

In the description of the present disclosure, terms “first” and “second” are used for descriptive purposes only and shall not be understood as indicating or implying relative importance or implicitly specifying the number of technical features. Therefore, a feature defined by the terms “first” and “second” may expressly or implicitly include one or more features. In the description of the present disclosure, “more than one” means two or more, unless otherwise expressly and specifically limited.

In the description of the present disclosure, it is to be noted that, unless otherwise expressly specified and limited, the terms “mounted”, “inter-connected”, “connected” shall be understood broadly. For example, connection may be fixed connection, or detachable connection, or integrally connected to form a one-piece structure; or mechanical connection, or electrical connection, or communicative connection; or direct connection, or indirect connection through an intermediate medium, or internal connection within two elements; or an interaction between the two elements.

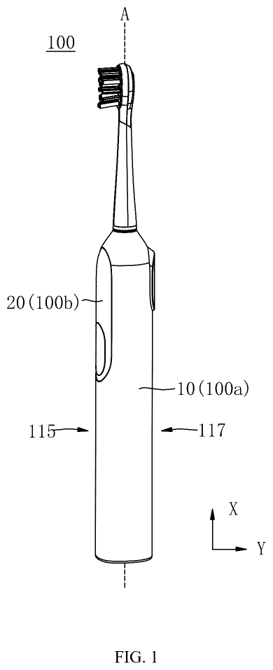

As shown in FIGS. 1, 2, 3, 5, 7, and 9, the oral care device 100 includes: a first portion 100a, a second portion 100b, and a communication assembly 30 disposed inside the first portion 100a. The first portion is metallic, and the second portion is non-metallic. The second portion 100b is connected to the first portion 100a. The communication assembly 30 includes a signal transceiver 31. The signal transceiver 31 is disposed corresponding to the second portion 100b. The signal transceiver 31 is configured to send signals to and/or receive signals from an exterior of the oral care device 100. Signals sent by the signal transceiver 31 and/or signals received by the signal transceiver 31 are allowed to pass through the second portion.

An interior of the oral care device 100 may be interpreted as an interior of a housing formed by the first portion 100a and the second portion 100b. Similarly, the exterior of the oral care device 100 may be interpreted as an exterior of the housing formed by the first portion 100a and the second portion 100b.

It is understood that, during the signals propagating, a metal structure may cause an impedance of the signal transceiver to have frequency deviation, and transceiving performance of the signal transceiver is affected seriously. In addition, the metal structure may absorb and shield signals of an antenna, resulting in a large loss of the signals during transmission, so that information or instructions cannot be accurately transmitted. Therefore, in the present disclosure, the second portion 100b that is non-metallic and the signal transceiver 31 are disposed correspondingly, and the first portion 100a that is metallic is prevented from affecting the signal transceiving function of the antenna. At least a portion of a signal transceiving portion of the signal transceiver 31 is ensured to be located within a range where the second portion 100b is located. The signals sent by the signal transceiver 31 and/or the signals received by the signal transceiver 31 are able to pass through the second portion 100b. Therefore, the signal transmission quality and the signal strength are ensured.

Exemplarily, a distance between the signal transceiver 31 and the second portion 100b is less than a wavelength of the signals sent by the signal transceiver 31 and/or the signals received by the signal transceiver 31.

In the embodiments of the present disclosure, the second portion 100b runs through at least a part of the first portion 100a. For example, the second portion 100b runs through a bottom of the first portion 100a, and in another example, the second portion 100b runs through one side of the first portion 100a.

Exemplarily, a size of the second portion 100b is less than a size of the first portion 100a. For example, the sizes of the second portion 100b and the first portion 100a may be an area, occupied by the second portion 100b and the first portion 100a, of an overall outer surface of the oral care device 100.

In one embodiment, the first portion 100a that is metallic is configured as a one-piece structure. In another embodiment, the first portion 100a that is metallic may be formed from a plurality of portions. The present disclosure does not limit configuration of the first portion 100a. In the following, the first portion 100a is configured as a handle-held shell 10 or a handle-held portion 11 of the oral care device 100, as an example.

In one embodiment, the second portion 100b that is non-metallic may be a portion of the oral care device 100, such as a bottom cover 13 of the oral care device 100, a panel 20 of the oral care device 100, or a non-metallic portion on the outer surface of the oral care device 100 other than the bottom cover 13 or the panel 20. In another embodiment, a plurality of second portions 100b may be disposed. The plurality of second portions 100b may be the bottom cover 13 of the oral care device 100 and the panel 20 of the oral care device 100, or may be non-metallic portions on the outer surface of the oral care device 100 other than the bottom cover 13 or the panel 20. The present disclosure does not limit the second portion 100b. In the following, the second portion 100b is configured as the bottom cover 13 or the panel 20, as an example.

Specifically, as shown in FIGS. 1 to 6, in the embodiment, the present disclosure takes the examples that the first portion 100a is the hand-held shell 10 and the second portion 100b is the panel 20 for further illustration. It should be understood that the first portion 100a is not limited to the hand-held shell 10. For example, when the hand-held shell 10 includes a plurality of components, such as the hand-held portion and the bottom cover, the first portion 100a may be the hand-held portion or a combination of the hand-held portion and the bottom cover.

As shown in FIGS. 1-3, the oral care device 100 of the present disclosure includes the hand-held shell 10, the panel 20, and the communication assembly 30. The hand-held shell is metallic, and the panel is non-metallic. The hand-held shell 10 defines a receiving cavity 101 and a through hole 103 communicated to the receiving cavity 101. The panel 20 is mounted on the hand-held shell 10 and covers the through hole 103. The communication assembly 30 is disposed inside the receiving cavity 101. The communication assembly 30 includes the signal transceiver 31. The signal transceiver 31 is disposed corresponding to the panel 20. The signal transceiver 31 is configured to send the signals to the exterior of the hand-held shell 10 and/or receive the signals from the exterior of the hand-held shell 10. The panel 20 is configured to allow the signals sent by the signal transceiver 31 and/or the signals received by the signal transceiver 31 to pass through.

In the oral care device 100 of the present disclosure, in the case that the signal transceiver 31 is disposed at the position facing the panel 20, the panel 20 that is non-metallic is partially or completely located in a signal transceiving region of the signal transceiver 31. The hand-held shell 10 that is metallic is staggered from the signal transceiving region. In this way, an influence, caused by the metallic hand-held portion, on the signal transceiving function of the signal transceiver 31 is avoided as much as possible, ensuring the signal transmission quality and signal strength.

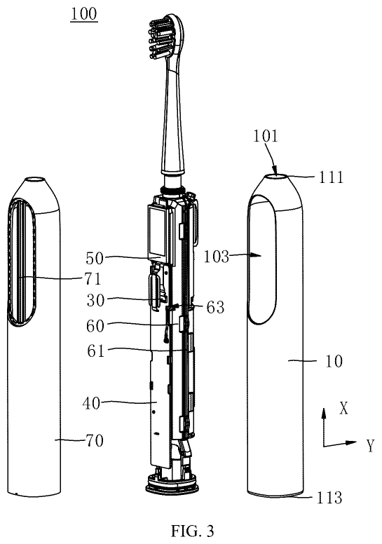

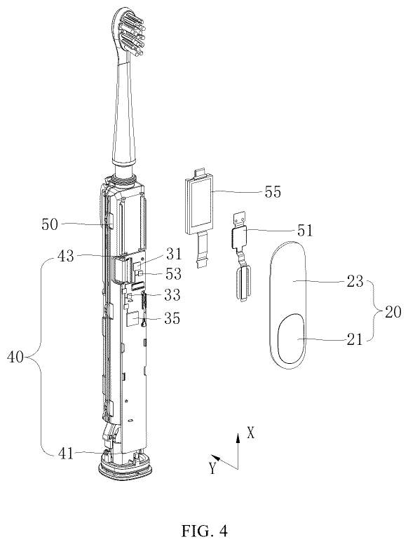

As shown in FIGS. 3 and 4, in some embodiments, the hand-held shell 10 is substantially a shell structure that receives partial structures of the oral care device 100. The hand-held shell 10 defines the receiving cavity 101. The partial structures of the oral care device 100 can be disposed inside the receiving cavity 101. A material of the hand-held shell 10 includes, but is not limited to, a metal or an alloy. During signal propagation, the hand-held shell 10 that is metallic may cause the impedance of the signal transceiver 31 to have frequency deviation and seriously affect transceiving performance of the signal transceiver 31. In addition, the hand-held shell 10 that is metallic may absorb and shield the signals sent by the signal transceiver 31 or the signals transmitted to the signal transceiver 31 from an external device, resulting in a large loss of signals during transmission, and information or instructions may not be accurately transmitted. The through hole 103 defined in the hand-held shell 10 that is metallic may allow the signals to pass through, and the panel 20 covering the through hole 103 also allows the signals to pass through. In this way, blocking and shielding of the signals by the hand-held shell 10 that is metallic may be reduced.

In some embodiments, the hand-held shell 10 includes a top end 111 and a bottom end 113 opposite to the top end 111. The hand-held shell 10 defines a center axis A, a first direction X, and a second direction Y. The center axis A is an axis dividing the hand-held shell 10 into two portions that are symmetrical to each other about the center axis A. In a case that the hand-held shell 10 is an axisymmetric three-dimensional structure, the center axis A passes through a center of the top end 111 of the hand-held shell 10 and a center of the bottom end 113 of the hand-held shell 10. That is, the first direction X of the hand-held shell 10 may be a direction that is straightly extending from the center of the top end 111 of the hand-held shell 10 to the center of the bottom end 113 of the hand-held shell 10 or a direction that is straightly extending from the center of the bottom end 113 of the hand-held shell 10 to the center of the top end 111 of the hand-held shell 10, which is not limited herein. The first direction X is understood as a direction along the center axis A of the hand-held shell 10 or as a lengthwise direction X of the hand-held shell 10. The second direction Y may be a direction that is straightly extending between any two opposite sides of the hand-held shell 10, which is not limited herein. The second direction Y is understood as a direction perpendicular to the first direction X or as a direction perpendicular to the center axis A of the hand-held shell 10. Outer contours of cross sections of the hand-held shell 10 may be, but not limited to, squared, oval, triangular, quadrilateral or pentagonal. In some embodiments, in the first direction X from the bottom end 113 of the hand-held shell 10 to the top end 111 pf the hand-held shell 10, sizes of the outer contours of the cross sections of the hand-held shell 10 gradually change. For example, the sizes of the outer contours of the cross sections of the hand-held shell 10 firstly remain constant and then gradually decrease; or firstly increase and then decrease; or varies for a plurality of times. In other embodiments, in the first direction X from the bottom end 113 of the hand-held shell 10 to the top end 111 of the hand-held shell 10, the sizes of the outer contours of the cross sections of the hand-held shell 10 remain constant.

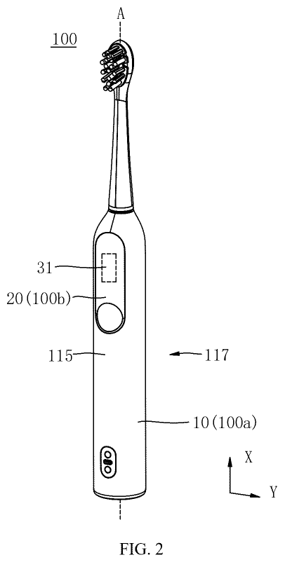

As shown in FIG. 1, in some embodiments, the hand-held shell 10 includes a first side 115 and a second side 117. The first side 115 of the hand-held shell 10 and the second side 117 of the hand-held shell 10 may be two sides opposite to each other in the second direction Y or two sides adjacent to each other, which are not limited herein. In some implementations, as shown in FIG. 2, the signal transceiver 31 is disposed at the first side 115 of the hand-held shell 10. In this case, the through hole 103 is defined in the first side 115 of the hand-held shell 10 to enable the panel 20, which is mounted at the through hole 103 and disposed at the first side 115 of the hand-held shell 10, to face the signal transceiver 31. In other embodiments, as shown in FIG. 1, the signal transceiver 31 is disposed at the second side 117 of the hand-held shell 10. In this case, the through hole 103 is defined in the second side 117 of the hand-held shell 10 to enable the panel 20, which is mounted at the through hole 103 and disposed at the second side 117 the hand-held shell 10, to face the signal transceiver 31. The signal transceiver 31 faces the panel 20, which means that the signal transceiving range of the signal transceiver 31 is at least partially overlapped with the panel 20, an edge of the signal transceiving range is completely staggered from an edge of the through hole 103 of the hand-held shell 10 (i.e., an edge of the panel 20), the signal transceiver 31 and the panel 20 are disposed directly corresponding to each other in the second direction Y, or the signal transceiver 31 is completely located within a projection of the panel 20 in the second direction Y. When the signal transceiver 31 and the panel 20 are always facing to each other, it is ensured that the signals sent from a signal end of the signal transceiver 31 are received, by passing through the panel 20, by the external device as much as possible; or the signals sent by the external device are transmitted, by passing through the panel 20, to the signal end of the signal transceiver 31 as much as possible. In this way, the hand-held shell 10 that is metallic is prevented from blocking the signals or affecting the quality of the signal transmission.

As shown in FIGS. 3 and 4, in some embodiments, the panel 20 is substantially a plate-shaped structure disposed at the through hole 103 of the hand-held shell 10 and sealing the through hole 103. The panel 20 is non-metallic, and a material of the panel 20 includes, but is not limited to, plastic, silicone, or rubber. The signals sent by the signal transceiver 31 or the signals received by the signal transceiver 31 are able to pass through the panel 20. Therefore, in a case that the signal transceiver 31 is located closer to the panel 20 than the hand-held shell 10, an overlapping area between the signal transceiving region of the signal transceiver 31 and the panel 20 is increased, and the blocking and shielding, caused by the hand-held shell 10 that is metallic, of the signals are reduced. In some embodiments, the panel 20 is mounted on the first side 115 of the hand-held shell 10. In this case, the signal end of the signal transceiver 31 is also disposed at the first side 115 of the hand-held shell 10 and disposed to face the panel 20. In other embodiments, the panel 20 is mounted on the second side 117 of the hand-held shell 10. In this case, the signal transceiver 31 may be disposed on the second side 117 of the hand-held shell 10; or a portion of the signal transceiver 31 is disposed on the first side 115 of the hand-held shell 10 and another portion (i.e., the signal end) of the signal transceiver 31 is disposed on the second side 117 of the hand-held shell 10 to be always facing the panel 20.

In some embodiments, the panel 20 includes a pressing portion 21. The pressing portion 21 is a partial structure or a partial region of the panel 20 that can be deformed or micro-deformed. The pressing portion 21 includes a flexible structure, and a material of the pressing portion 21 may the same as or different from a material of the rest of the panel 20, which is not limited herein. When a user applies a force to the pressing portion 21 and deforms the pressing portion 21, the pressing portion 21 triggers a trigger structure of the oral care device 100 disposed inside the hand-held shell 10 to enable the oral care device 100 to realize functions such as switching between various operating modes, turn on or turn off of the oral care device 100, and the like.

In some embodiments, the panel 20 further includes a light-transmitting portion 23. When the structure of the oral care device 100 disposed inside the hand-held shell 10 and opposite to the light-transmitting portion 23 of the panel 20 emits light, the light passes through the light-transmitting portion 23 to emit out of the hand-held shell 10. In this way, the user can obtain a current operating state of the oral care device 100 and various parameter information of the oral care device 100 based on changes in the light or an image formed by the light.

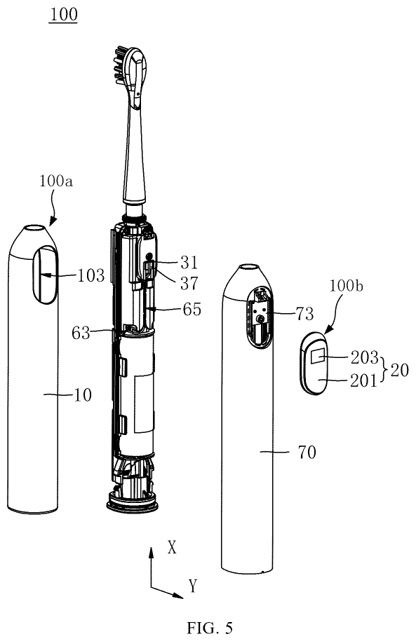

As shown in FIG. 5, in some embodiments, the panel 20 is a completely light-transmitting region but are not transparent. In this case, the user cannot observe internal structure disposed inside the hand-held shell 10 and disposed opposite to the panel 20 from the exterior of the hand-held shell 10. However, the light emitted from the hand-held shell 10 can still be observed by the user. In other embodiments, the panel 20 includes a first region 201 and a second region 203. The first region 201 and the second region 203 are connected to each other. The first region 201 does not allow the light to pass through, and the second region 203 allows the light to pass through. The signal transceiver 31 is disposed opposite to the first region 201, so that a detailed structure of the signal transceiver 31 cannot be observed by the user from the exterior of the hand-held shell 10. Other structures, which can emit light and are disposed inside the hand-held shell 10, are disposed corresponding to the second region 203, so that the light is allowed to emit from the second region 203 and is observed by the user.

In some implementations, connection between the panel 20 and the through hole 103 is seamless. The panel 20 and an inner wall of the through hole 103 are integrally-formed into a one-piece structure; or the panel 20 and the through hole 103 are separately molded. In the case that the panel 20 and the hand-held shell 10 are separately molded, in some embodiments, a sealing structure is disposed between the panel 20 and the inner wall of the through hole 103 of the hand-held shell 10 to fill a gap therebetween. In other embodiments, the panel 20 and the inner wall of the through hole 103 of the hand-held shell 10 are connected in a seamless manner, such as an interference-fit connection, connection by glue, or the like. The seamless connection between the panel 20 and the inner wall of the through hole 103 of the hand-held shell 10 prevents external water steams, dusts or bubbles from entering the hand-held shell 10 through the gap between the panel 20 and the inner wall of the through hole 103 of the hand-held shell 10, so that structural damage of the oral care device 100 is prevented.

As shown in FIGS. 3 and 4, in some embodiments, the communication assembly 30 is a structure that is substantially configured to send the signals from the signal transceiver 31 outwardly based on instructions or to receive and read the signals sent from the external device to the oral care device 100 to obtain instructions. The communication assembly 30 includes, but is not limited to, a WIFI module, a BLUETOOTH module, or Zigbee. The oral care device 100 further includes a first circuit board 40. The first circuit board 40 is a structure that is electrically connected to the communication assembly 30 to supply power to the communication assembly 30. In some embodiments, the signal transceiver 31 of the communication assembly 30 is disposed on the first circuit board 40 and is directly electrically connected to the first circuit board 40. In other embodiments, the signal transceiver 31 is disposed on other structures of the oral care device 100 and is indirectly electrically connected to the first circuit board 40.

In some embodiments, the signal transceiver 31 is an electrical member or an electrical member group, configured to receive the signals from the exterior and to send the signals to the exterior. In some embodiments, the signal transceiver 31 may be a conductive metal antenna or a fiberglass antenna. In other embodiments, the signal transceiver 31 includes, but is not limited to, an IPEX external antenna, an on-board antenna, or a ceramic antenna. The IPEX external antenna is a structure that is independently mounted inside the hand-held shell 10 and is connected to an external antenna. The IPEX external antenna can provide signals with better quality. The on-board antenna takes a PCB (a rigid circuit board and/or a flexible circuit board) as a medium, and the antenna is directly disposed on the PCB. The ceramic antenna is a signal transceiver that is independently disposed in the hand-held shell 10. A signal end of the ceramic antenna is located in a ceramic housing, which cannot be damaged easily by touching and can be assembled easily.

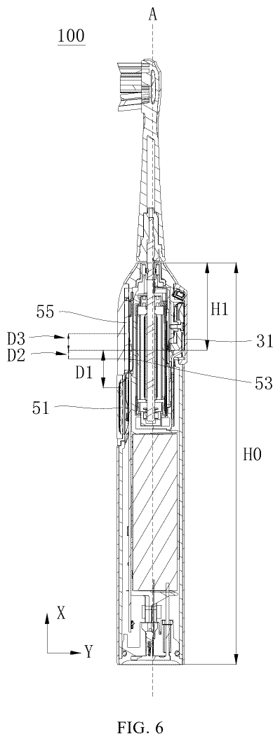

As shown in FIG. 6, in some embodiments, a distance H1 between the signal transceiver 31 and the top end 111 of the hand-held shell 10 is not more than ¼ of a total length H0 of the hand-held shell 10 in the first direction X. When the signal transceiver 31 is disposed at a position having the distance H1 between the signal transceiver 31 and the top end 111 of the hand-held shell 10 being less than ¼ of the total length H0 of the hand-held shell 10, the signal transceiver 31 is located at one side of the hand-held shell 10 where the top end 111 of the hand-held shell 10 is located. On the one hand, since the panel 20 is also disposed closer to the one side where the top end 111 of the hand-held shell 10 is located with respect to a peripheral wall of the hand-held shell 10, the signal transceiver 31 is enabled to correspond to the panel 20, which is also disposed on the one side of the hand-held shell 10 that is closer to the top end 111 of the hand-held shell 10, when the distance H1 between the signal transceiver 31 and the top end 111 of the hand-held shell 10 is not greater than ¼ of the total length H0 of the hand-held shell 10. On the other hand, in the case that the signal transceiver 31 is disposed on the one side of the hand-held shell 10 closer to where the top end 111 is located of the hand-held shell 10, the signal transceiver 31 is staggered from a position of the oral care device 100 held by the user. In this way, a signal transceiving path of the signal transceiver 31 is prevented from being blocked when the oral care device 100 is being held.

In some embodiments, a plurality of signal transceivers 31 are provided. Each of the signal transceivers 31 faces the panel 20 and is electrically connected, directly or indirectly, to the first circuit board 40. The plurality of signal transceivers 31 enhance strength of the signals transmitted to the exterior of the hand-held shell. In addition, the plurality of signal transceivers 31 are disposed at various locations, so that the signal transceiving region of the signal transceivers 31 is increased. In this way, a range from which the signals are transmitted to be received by the signal transceivers 31 and/or a range to which the signals sent by the plurality of signal transceivers 31 is increased. Furthermore, each of the signal transceivers 31 is corresponding to the panel 20. Therefore, the signals sent from the signal end of each of the signal transceivers 31 or the signals received by the signal end of each of the signal transceivers 31 are prevented from being obscured by other structures of the oral care device 100. In some embodiments, only one panel 20 is disposed, and the plurality of signal transceivers 31 respectively face different locations of the panel 20. In other embodiments, a plurality of panels 20 are provided, and each of the panels 20 corresponds to at least one of the plurality of signal transceivers 31. When the plurality of panels 20 are provided, each of the panels 20 may correspond to a corresponding one of the plurality of signal transceivers 31, or each of the panels 20 corresponds to more than one signal transceiver 31. For ease of illustration, the present disclosure takes an example that only one signal transceiver 31 is provided for further illustration.

In some embodiments, the communication assembly 30 further includes a matching circuit 33 and a main chip 35. The matching circuit 33 is disposed between the main chip 35 and the signal transceiver 31. The matching circuit 33 includes a plurality of circuit elements. The matching circuit 33 is electrically connected to the signal transceiver 31 and the main chip 35 to enable instruction signals sent from the main chip 35 to be transmitted to the signal transceiver 31 and/or to enable the signals received by the signal transceiver 31 to be further transmitted to the main chip 35 to enable the main chip 35 to control operations of other structures. The main chip 35 is a structure that controls the signal transceiver 31 and the matching circuit 33 and receives and analyze the signals sent from the signal transceiver 31. The main chip 35 is disposed on the first circuit board 40 and is spaced from the signal transceiver 31. The main chip 35 is electrically connected to the signal transceiver 31 via the matching circuit 33. The main chip 35 can read the signals received by the signal transceiver 31 and control the signal transceiver 31 to send signals. In the case that the signal transceiver 31 is disposed on the first circuit board 40, both the matching circuit 33 and the main chip 35 are disposed on the first circuit board 40. In addition, since the signal transceiver 31 is disposed on the first circuit board, the signal transceiver 31 occupies a small space inside the hand-held shell 10, and the signal transceiver 31 is prevented from being obstructed by other structures disposed inside the hand-held shell 10.

As shown in FIGS. 1 and 5, in some embodiments, the communication assembly 30 further includes a second circuit board 37, and the signal transceiver 31 is disposed on the second circuit board 37. The signal transceiver 31 is electrically connected to the first circuit board 40 via the second circuit board 37 and a conductive piece. The conductive piece is a structure that is electrically connected to the signal transceiver 31, the matching circuit 33, and the main chip 35. The conductive piece may be an independent wire or a circuit structure built in the first circuit board 40 and/or the second circuit board 37, which is not limited herein. In the case that the signal transceiver 31 is disposed on the second circuit board 37, the signal transceiver 31 may be an independent structure disposed on the second circuit board 37 or a circuit structure integrally formed with the second circuit board 37 for sending signals or receiving signals. In the case that the signal transceiver 31 is disposed on the second circuit board 37, the second circuit board 37 and the signal transceiver 31 are located at any position inside the hand-held shell 10 that allows the signals received or sent. The location of the signal transceiver 31 is more flexible. In the case that the signal transceiver 31 is damaged or aged, only the second circuit board 37 needs to be replaced, so that a new signal transceiver 31 may be replaced easily. In the case that the signal transceiver 31 is disposed on the first side 115 of the hand-held shell 10, the second circuit board 37 is disposed on the first side 115 of the hand-held shell 10. In the case that the signal transceiver 31 is disposed on the second side 117 of the hand-held shell 10, the second circuit board 37 is disposed on the second side 117 of the hand-held shell 10.

In some implementations, in the case that the signal transceiver 31 is disposed on the second circuit board 37, the main chip 35 is mounted on the first circuit board 40, and the matching circuit 33 is mounted on either the first circuit board 40 or the second circuit board 37. In some embodiments, the first circuit board 40 and the second circuit board 37 are electrically connected to each other by wires. In other embodiments, the second circuit board 37 is a flexible circuit board that is directly connected to the first circuit board 40. The signal transceiver 31 is electrically connected to the first circuit board 40 via the second circuit board 37, and the signal transceiver 31 disposed on the second circuit board 37 may be disposed at various locations inside the hand-held shell 10 according to the usage demands.

As shown in FIGS. 1 and 4, in some embodiments, the first circuit board 40 is disposed at the first side 115 of the hand-held shell 10, and the signal transceiver 31 is electrically connected to the first circuit board 40. The panel 20 may be disposed at any position of the hand-held shell 10. In the case that the panel 20 and the first circuit board 40 are disposed on two different sides of the hand-held shell 10, the signal end of the signal transceiver 31 always corresponds to the panel 20, so that the signals sent by the signal transceiver 31 or the signals received by the signal transceiver 31 are prevented from being blocked or shielded by the hand-held shell 10 as much as possible. In some embodiments, the signal transceiver 31 is mounted on the first circuit board 40 and located on one side of the first circuit board 40 facing the panel 20. In the case that the panel 20 faces the first circuit board 40, the signal transceiver 31 disposed on the one side of the first circuit board 40 also faces the panel 20, so that no obstructive structures of the oral care device 100 are disposed between the panel 20 and the signal transceiver 31, and the signals sent by the signal transceiver 31 or the signals sent by the external device to be received by the signal transceiver 31 can directly pass through the panel 20 that is non-metallic. Therefore, a loss of the signals during transmission is reduced. In other embodiments, an electrical connection end of the signal transceiver 31 is disposed on any side of the first circuit board 40, and the signal end of the signal transceiver 31 extends to a position facing the panel 20. In this way, the range in which the signals sent by and to be received by the signal transceiver 31 is prevented from being blocked and/or shielded by the hand-held shell 10 that is metallic or other metallic structures inside the oral care device 100.

As shown in FIG. 3, in some embodiments, the first circuit board 40 includes a first end 41 and a second end 43 opposite to the first end 41 in the first direction X. The first end 41 the first circuit board 40 is disposed closer to the bottom end 113 of the hand-held shell 10 than the second end 43 of the first circuit board 40. The signal transceiver 31 is disposed at the second end 43 of the first circuit board 40 and is located closer to the bottom end 113 of the hand-held shell 10. In the case that the signal transceiver 31 is disposed at the second end 43 of the first circuit board 40, a path for the signals transmitted to the panel 20 inside the hand-held shell 10 is shorter. Therefore, the loss of the signals sent from the signal transceiver 31 is reduced. In addition, since the signal transceiver 31 is disposed closer to the second end 43 of the first circuit board 40, a relative distance from the signal transceiver 31 to the external device that sends the signals is reduced, so that the information conveyed by the external signals received by the signal transceiver 31 is more complete.

In the case that the main chip 35, the matching circuit 33, and the signal transceiver 31 are all disposed on the first circuit board 40, the signal transceiver 31 and the matching circuit 33 are disposed closer to the second end 43 of the first circuit board 40 than the main chip 35. The matching circuit 33 is disposed between the main chip 35 and the signal transceiver 31 to minimize a mounting space occupied by the matching circuit 33 on the first circuit board 40, so that electrical components on the first circuit board 40 are disposed more compactly, and arrangement layout of the electrical components on the first circuit board 40 is more reasonable. In addition, since the signal transceiver 31 is disposed closer to the second end 43 of the first circuit board 40, the signal transceiver 31 is disposed corresponding to the panel 20, so that the signals sent by the signal transceiver 31 or the signals received by the signal transceiver 31 are allowed to pass through the panel 20 as much as possible without being blocked by the hand-held shell 10 that is metallic. When the signal transceiver 31 is disposed closer to the second end 43 of the first circuit board 40, a signal sending and receiving path of the signal transceiver 31 is prevented from being obscured when the oral care device 100 is being held by the user.

As shown in FIGS. 3 and 4, in some embodiments, the oral care device 100 further includes a functional element 50. The functional element 50 is an element that achieves various functions of the oral care device 100. The functional element 50 is electrically connected to the first circuit board 40 to perform various functions. In some embodiments, the signal transceiver 31 and the functional element 50 are both disposed on the first circuit board 40, and the signal transceiver 31 is spaced apart from the functional element 50. The matching circuit 33 is disposed on the first circuit board 40. The main chip 35 is disposed on the first circuit board 40 and is spaced apart from the functional element 50 and the signal transceiver 31. The main chip 35 is electrically connected to the functional element 50. In other embodiments, the signal transceiver 31 is not disposed on the first circuit board 40, and the main chip 35, the matching circuit 33, and the functional element 50, which are disposed on the first circuit board 40, are respectively electrically connected to the signal transceiver 31 through respective conductive pieces.

In some embodiments, the signal transceiver 31 is disposed at a position having a distance within a predetermined distance to the functional element 50. Since the functional element 50 needs to be always facing the panel 20 in order to achieve functions, the signal transceiving region of the signal transceiver 31 is overlapped with the panel 20 as much as possible when the distance between the functional element 50 and the signal transceiver 31 is less than the predetermined distance. In this way, a portion of the signals blocked by the hand-held shell 10 that is metallic or other structures of the oral care device 100 is reduced. The distance between the functional element 50 and the signal transceiver 31 is a distance in three dimensions. That is, the distance between the functional element 50 and the signal transceiver 31 can be calculated either in the first direction X or along any direction different from the second direction X, which is not limited herein.

In some embodiments, the functional element 50 is spaced apart from the panel 20 in the second direction Y. That is, a certain distance is defined between the functional element 50 and the panel 20. In some embodiments, the functional element 50 may include a metallic structure or the like, that can block signals, shield signals, or affect signal transmission. Therefore, in the case that the functional element 50 is spaced apart from the panel 20, edges of the signal transceiving region of the signal transceiver 31 disposed close to the functional element 50 are staggered from edges of the functional element 50. In this way, the functional element 50 cannot block the signal transceiving region of the signal transceiver, or an area of the signal transceiving region blocked by the functional element 50 is reduced, so that the signal transmission effect is better.

As shown in FIG. 5, in some embodiments, the second region 203 of the panel 20 is light transmitting. The functional element 50 faces the second region 203. By arranging the functional element 50 facing the second region 203, light signals sent from the functional element 50 is enabled to pass through the panel 20 to the exterior for being recognized. In the case that the portion of the panel 20 facing the signal transceiver 31 allows the light to pass through but is not transparent or does not allow any light to pass through, the signal transceiver 31 disposed inside the hand-held shell 10 and facing the panel 20 is partially blocked by the non-transparent portion of the panel 20 or by the first region 201 that does allow any light to pass through. In this way, an appearance of the oral care device 100 is more aesthetically pleasing.

As shown in FIG. 6, in some embodiments, the functional element 50 includes a button 51, and the button 51 is substantially an electrical element and/or a circuit structure that can be triggered to change an operating state of the oral care device 100. The button 51 is disposed in the receiving cavity 101 and is electrically connected to the first circuit board 40. The pressing portion 21 of the panel 20 faces the button 51. When the user presses on the pressing portion 21, the pressing portion 21 triggers the button 51 to change the operating state of the oral care device 100. A first predetermined distance DI is defined between the signal transceiver 31 and the button 51 in the first direction X. A value of the first predetermined distance DI is related to a signal transceiving range of the signal transceiver 31. Since the button 51 always faces the panel 20, when a distance between the button 51 and the signal transceiver 31 in the first direction X is less than the first predetermined distance D1, the signal transceiving region of the signal transceiver 31 corresponds to at least partial structures of the panel 20. In this way, the signals can be transmitted to the external device via the panel 20 or the signals from the exterior can be received by the signal transceiver 31 via the panel 20, providing a good signal transmission effect. When the distance between the button 51 and the signal transceiver 31 in the first direction X is not less than the first predetermined distance D1, both the signals sent from the signal transceiver 31 and the signals received by the signal transceiver 31 are blocked.

In some embodiments, the functional element 50 includes an indicator 53. The indicator 53 is configured to indicate a current operating state of the oral care device 100 by means of sound, light, or electrical signals. The indicator 53 is disposed in the receiving cavity 101 and is electrically connected to the first circuit board 40. In the case that the indicator 53 is an element that indicates the current operating state of the oral care device 100 by means of light, the indicator 53 is disposed facing the light-transmitting portion 23. The light-transmitting portion 23 of the panel 20 allows the light emitted from the indicator 53 to be transmitted to the exterior of the hand-held shell 10. The indicator 53 is configured to emit light towards the exterior of the hand-held shell 10 through the light-transmitting portion 23. A second predetermined distance D2 is defined between the signal transceiver 31 and the indicator 53 in the first direction X. The second predetermined distance D2 may be the same as or different from the first predetermined distance D1. Since the indicator 53 always faces the light-transmitting portion 23 of the panel 20, in the case that a distance between the indicator 53 and the signal transceiver 31 in the first direction X is less than the second predetermined distance D2, the signal transceiving region of the signal transceiver 31 corresponds to at least partial structures of the panel 20 that do not allow the light to pass through, and the signals are allowed to be transmitted to the external device via the panel 20 or the signals are allowed to be received by the signal transceiver 31 by passing through the panel 20. In this way, the signals are sent more effectively. When the distance between the indicator 53 and the signal transceiver 31 in the first direction X is not less than the second predetermined distance D2, both the signals sent from the signal transceiver 31 and the signals sent from the exterior to the signal transceiver 31 are blocked.

In some embodiments, the functional element 50 includes a display 55, which is disposed in the receiving cavity 101 and electrically connected to the first circuit board 40. The display 55 faces the light-transmitting portion 23, and the display 55 is an electrical structure or an electrical assembly that displays an image through the light-transmitting portion 23 to the exterior of the hand-held shell 10. A displaying region of the display 55 corresponds to the light-transmitting portion 23 of the panel 20 to enable the user to see the displayed image from the exterior of the hand-held shell 10. The display 55 displays information such as the current operating state of the oral care device 100 and various parameters of the oral care device 100. A third predetermined distance D3 is defined between the signal transceiver 31 and the display 55 in the first direction X. The third predetermined distance D3, the second predetermined distance D2, and the first predetermined distance DI may be the same as or different from each other. Since the indicator 53 always corresponds to the light-transmitting portion 23 of the panel 20, in the case that the distance between the display 55 and the signal transceiver 31 in the first direction X is less than the second predetermined distance D2, the signal transceiving region of the signal transceiver 31 corresponds to at least partial structures of the panel 20 that does not allow light to pass through, and the signals can pass through the panel 20 to be transmitted to the external device or the signals from the exterior can pass through the panel 20 to be received by the signal transceiver 31. Therefore, the signal transmission effect is better. In the case that the distance between the display 55 and the signal transceiver 31 in the first direction X is not less than the second predetermined distance D2, the signals sent from the signal transceiver 31 and the signals sent from the exterior to the signal transceiver 31 may be blocked. In particular, in the case that both the signal transceiver 31 and the display 55 face the panel 20, a spacing needs to be defined between the display 55 and the panel 20 to reduce the blocking, by the display 55, against the signals sent from the signal transceiver 31 to the exterior of the hand-held shell 10 and against the signals sent from the external device to the signal transceiver 31.

As shown in FIGS. 3 and 4, in some embodiments, the oral care device 100 further includes a movement assembly 60. The movement assembly 60 is mounted inside the hand-held shell 10, supports the first circuit board 40 and other structures of the oral care device 100, and allows the first circuit board 40 and other structures of the oral care device 100 to be mounted thereon. The movement assembly 60 is received in the receiving cavity 101, and in some embodiments, the movement assembly 60 is detachably mounted to an inner wall of the hand-held shell 10. A connection method of the movement assembly 60 mounted to the inner wall of the hand-held shell 10 includes, but not limited to, threaded connection, snap connection, or bolt connection. In other embodiments, the movement assembly 60 is fixed to the inner wall of the hand-held shell 10, and a fixation method thereof includes, but not limited to, hot-melt connection, glued connection, or welded connection. In the case that only partial structures of the signal transceiver 31 is electrically connected to the first circuit board 40, the partial structures of the signal transceiver 31 are secured to the movement assembly 60, and the signal end of the signal transceiver 31 extends to a position facing the panel 20. The movement assembly 60 is configured to allow the signal transceiver 31 to be mounted thereon. In the case that the signal transceiver 31 is an independent antenna, the signal transceiver 31 extends through the movement assembly 60, and the electrical connection end of the signal transceiver 31 is electrically connected to the first circuit board 40, which is mounted on the movement assembly 60 and is located on a different side from the panel 20. The signal end of the signal transceiver 31 protrudes from the movement assembly 60 or is embedded in a surface of the movement assembly 60, and is always corresponding to the panel 20. In this way, the signals sent from the signal end of the signal transceiver 31 or the signals received by the signal end of the signal transceiver 31 are prevented from being blocked by other structures of the oral care device 100.

In some implementations, in the second direction Y, the movement assembly 60 includes a first side and a second side opposite to the first side. The first side of the movement assembly 60 and the first side 115 of the hand-held shell 10 face a same direction. The first circuit board 40 is secured to the first side of the movement assembly 60, and the signal end of the signal transceiver 31 is secured to the second side of the movement assembly 60. In some embodiments, when the signal transceiver 31 is a strip-shaped antenna and is directly connected to the first circuit board 40, the electrical connection end of the signal transceiver 31 connected to the first circuit board 40 extends along the surface of the movement assembly 60 to reach the first side 115 of the hand-held shell 10, and the signal end of the signal transceiver 31 facing the panel 20 is disposed at the second end 43 of the first circuit board 40. In some other embodiments, as shown in FIG. 5, the movement assembly 60 defines a wiring hole 63 and a wiring groove 65. The wiring hole 63 extends through an outer housing of the movement assembly 60 in the second direction Y. The wiring groove 65 is defined in the second side of the movement assembly 60 and extends for a distance in the first direction X. At least a portion of the wiring groove 65 faces the panel 20. The electrical connection end of the signal transceiver 31 connected to the first circuit board 40 passes through the wiring hole 63 and is connected to the first circuit board 40 at the first side 115. The signal end of the signal transceiver 31 facing the panel 20 passes through the wiring hole 63 and is received in the wiring groove 65 to face the panel 20.

As shown in FIGS. 3 and 5, in some embodiments, the oral care device 100 further includes an inner liner 70, the inner liner 70 is substantially a cylindrical structure disposed inside and connected to the hand-held shell 10. The inner liner 70 is received in and connected to the receiving cavity 101. A material of the inner liner 70 includes, but not limited to, a non-metallic material, such as plastic, silicone, or rubber. Compared to the hand-held shell 10 that is metallic, the inner liner 70 can connect structures disposed inside the oral care device 100 to each other more securely, reducing shaking and collision of the structures inside the oral care device 100. In some embodiments, the inner liner 70 is integrally molded with and disposed inside the hand-held shell 10. In other embodiments, the inner liner 70 is a structure that is molded separately and then mounted within the hand-held shell 10. Sizes of outer contours of cross sections of the inner liner 70 are not greater than the sizes of inner contours of the cross sections of the hand-held shell 10, enabling the inner liner 70 to be mounted inside the hand-held shell 10. The movement assembly 60 is disposed inside and connected to the inner liner 70. Since the hand-held shell 10 is metallic, the structures inside the oral care device 100 may not be easily fixed to the hand-held shell 10 that is metallic, and it is costly to prepare a fixing structure to the interior of the hand-held shell 10 that is metallic. The inner liner 70 that is non-metallic is configured to connect the structures inside the oral care device 100. On the one hand, manufacturing costs of the oral care device 100 are reduced, and on the other hand, the structures inside the oral care device 100 are prevented from shaking therein, and the structures inside the oral care device 100 are protected.

In some embodiments, the inner liner 70 includes a support plate 73 at a position corresponding to the through hole 103, the support plate 73 is substantially protruding from a surface of the inner liner 70 and partially inserted into the through hole 103. The panel 20 is mounted on the support plate 73. Since both the support plate 73 and the panel 20 are non-metallic, the panel 20 is mounted on the support plate 73 more easily, and the panel 20 mounted on the support plate 73 is enabled to be tightly connected to the hand-held shell 10 that is metallic.

Further, in some embodiments, the inner liner 70 includes a connection portion 71. The movement assembly 60 is disposed inside the inner liner 70 and is disposed with a mating portion 61. The connection portion 71 and the mating portion 61 are mated to be connected to each other to connect the movement assembly 60 to the inner liner 70. In some embodiments, the connection portion 71 and the mating portion 61 are slidably mated to each other in the first direction X. In other embodiments, the connection portion 71 and the mating portion 61 can be rotatably, about the center axis A, mated to each other. The connection portion 71 is disposed on an inner peripheral wall of the inner liner 70, and the mating portion 61 is disposed on an outer peripheral wall of the movement assembly 60. In some embodiments, the connection portion 71 is a recess, which is recessed in a direction from the inner liner 70 towards an inner wall of the hand-held shell 10. The mating portion 61 is a protrusion, protruding in a direction from the movement assembly 60 towards the inner wall of the inner liner 70. In other embodiments, the connection portion 71 is a protrusion, protruding in a direction from the inner liner 70 towards the outer wall of the movement assembly 60. The mating portion 61 is a recess, which is recessed in a direction from the movement assembly 60 towards the inner wall of the inner liner 70. When the connection portion 71 and the mating portion 61 are mated to each other, the movement assembly 60 is mounted inside the inner liner 70. When the connection portion 71 and the mating portion 61 are mated in position, the movement assembly 60 does not shake or rotate violently inside the inner liner 70, and stability of connection between the structures inside the oral care device 100 is improved.

In summary, in the oral care device 100 of the present disclosure, when the signal transceiver 31 is disposed to face the panel 20, the non-metallic panel 20 is partially or entirely located in the signal transceiving region of the signal transceiver 31, and the hand-held shell 10 that is metallic is staggered with the signal transceiving region. In this way, the effect, caused by the hand-held shell 10 that is metallic, on the signal transceiving function of the signal transceiver 31 is avoided as much as possible, ensuring the signal transmission quality and the signal strength.

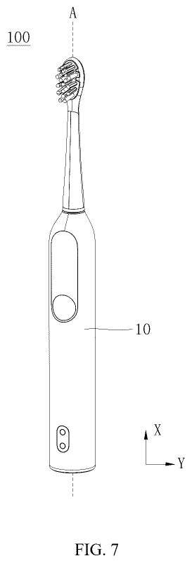

As shown in FIGS. 7 to 10, the embodiments of the present disclosure will be illustrated as an example, in which the first portion 100a is configured as the hand-held portion 11 and the second portion 100b is configured as the bottom cover 13.

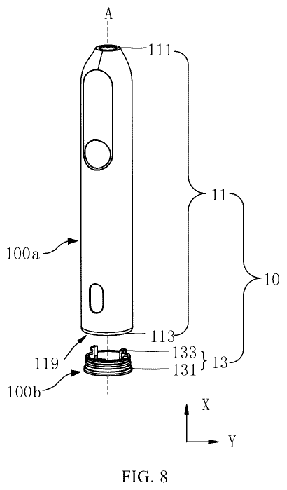

As shown in FIGS. 6 and 8, the oral care device 100 of the present disclosure includes the hand-held shell 10, the communication assembly 30 disposed inside the hand-held shell 10, and the first circuit board 50 disposed inside the hand-held shell 10. The hand-held shell 10 includes a hand-held portion 11 that is metallic and a bottom cover 13 that is non-metallic. The bottom cover 13 is connected to a bottom end 113 of the hand-held portion 11. The communication assembly 30 includes a signal transceiver 31 disposed corresponding to the bottom cover 13. The signal transceiver 31 is configured to send signals to the exterior of the hand-held shell 10 and/or receive signals sent from the exterior of the hand-held shell 10. The bottom cover 13 allows the signals sent by the signal transceiver 31 and/or the signals received by the signal transceiver 31 to pass through. The communication assembly 30 is electrically connected to the first circuit board 50.

In the oral care device 100 of the embodiments of the present disclosure, arranging the signal transceiver 31 on a side near the non-metallic bottom cover 13 avoids an influence, caused by the metallic hand-held portion 11, on the signal transceiving function of the antenna, ensuring the signal transmission quality and the signal strength. The signal transceiver 31 being disposed corresponding to the bottom cover 13 also ensures that at least a portion of the signal transceiving region of the signal transceiver 31 can be located within a range of the bottom cover 13.

In some embodiments, the hand-held portion 11 includes a top end 111 and a bottom end 113 opposite to the top end 111. The bottom end 113 of the hand-held portion 11 has an opening 119. Partial structures of the oral care device 100 can extend into the hand-held portion 11 and be mounted inside the hand-held portion 11. The bottom cover 13 covers the opening 119 and seals the opening 119, preventing external dusts, water steams, liquids or bubbles from entering the hand-held portion 11, so that the partial structures of the oral care device 100 inside the hand-held portion 11 are prevented from being damaged. The hand-held portion 11 is made of metal. A material of the hand-held portion 11 includes, but not limited to, aluminum, iron and alloys thereof. Metal causes the impedance of the signal transceiver 31 to have frequency deviation during the signal transmission and seriously affects the transceiving performance of the signal transceiver 31. The metal also absorbs and shields the signals sent by the signal transceiver 31 or the signals transmitted to the signal transceiver 31 from the exterior. Therefore, the hand-held portion 11 that is metallic leads to a large loss of the signals during the signal transmission, information or instructions may not be accurately transmitted. The bottom cover 13 is non-metallic, and the material of the bottom cover 13 includes, but not limited to, plastic, silicone or rubber. The signals sent from the signal transceiver 31 or the signals transmitted to the signal transceiver 31 from the exterior can pass through the bottom cover 13. Therefore, when the signal transceiver 31 is located closer to the bottom cover 13 with respect to the hand-held portion 11, the signal transceiving region of the signal transceiver 31 is partially overlapped with the bottom cover 13 as much as possible, which reduces the shielding and shielding effect of the hand-held portion 11 on the signals.

It is noted that the bottom end 113 of the hand-held portion 11 may be interpreted as the bottom end 113 of the hand-held shell 10, and the top end 111 of the hand-held portion 11 may be interpreted as the top end 111 of the hand-held shell 10.

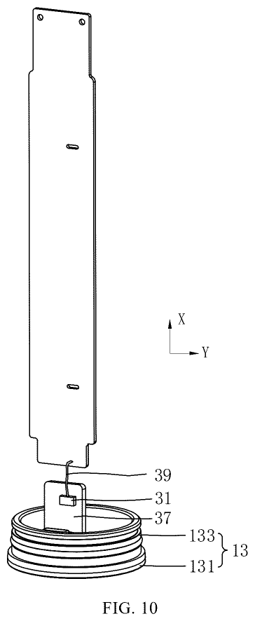

In some embodiments, the bottom cover 13 includes a blocking portion 131 and a fastening portion 133 extending from the blocking portion 131. The blocking portion 131 is substantially a plate-shaped structure disposed at one end of the fastening portion 133. The blocking portion 131 blocks the opening 119 of the bottom end 113 of the hand-held portion 11 to isolate the structures inside the oral care device 100 from the exterior and to prevent the water steams or dusts from entering the oral care device 100. In some embodiments, as shown in FIG. 2, the fastening portion 133 is substantially a hook-claw structure or a plate-shaped structure that extends into and is connected to the hand-held portion 11, enabling the bottom cover 13 to be mounted on the hand-held portion 11. In other embodiments, as shown in FIG. 10, the fastening portion 133 is substantially a cylindrical structure defining an internal cavity.

In some embodiments, the fastening portion 133 is mounted to the bottom end 113 of the hand-held portion 11 by threaded connection or snap connection. A partial structure of the blocking portion 131 is located outside the hand-held portion 11. In this case, an effect of the blocking portion 131 sealing the internal cavity of the hand-held portion 11 is optimal. In other embodiments, the outer peripheral wall of the fastening portion 133 is connected to the hand-held portion 11 by heat melt or adhesive connection. The blocking portion 131 fully extends into the hand-held portion 11 and abuts against the inner peripheral wall of the hand-held portion 11. When the fastening portion 133 is adhered to the hand-held portion 11, a distance between the inner wall of the fastening portion 133 and the signal transceiver 31 in the first direction X is less than a distance formed in one embodiment where the fastening portion 133 is directly snapped to the hand-held portion 11 or the fastening portion 133 is directly screwed with the hand-held portion 11. Furthermore, the fastening portion 133 can be completely located inside the hand-held portion 11, so as to enable the relative distance between the signal transceiver 31 and the fastening portion 133 of the bottom cover 13 to be shorter in the case that a mounting position of the signal transceiver 31 relative to the hand-held portion 11 remains unchanged. Since the signal transceiver 31 is disposed closer to the fastening portion 133, the efficiency of the signal transmission is increased.

As shown in FIG. 4, in some embodiments, the signal transceiver 31 is disposed inside the hand-held shell 10, and the distance between the signal transceiver 31 and the bottom cover 13 in the first direction X is less than the wavelength of the signals sent from and/or the wavelength of the signals received by the signal transceiver 31. When the distance between the signal transceiver 31 and the bottom cover 13 is less than the wavelength of the signals, the signals are less reflected or scattered during being emitted outwardly through the bottom cover 13 or transmitted to the signal transceiver 31. On the one hand, the bottom cover 13 is prevented from excessively blocking the signals, and the efficiency of the signal transmission is increased. On the other hand, the signal quality is improved, and loss of information is avoided.

In some embodiments, the signal transceiver 31 is directly disposed on the bottom cover 13, and in this case, the distance between the signal end of the signal transceiver 31 and the bottom cover 13 is small. In other embodiments, the signal transceiver 31 may be disposed at other positions inside the hand-held portion 11, and the signal end of the signal transceiver 31 extends to reach the bottom cover 13, so that the distance between the signal end of the signal transceiver 31 and the bottom cover 13 is short, and the signal transmission effect is improved.

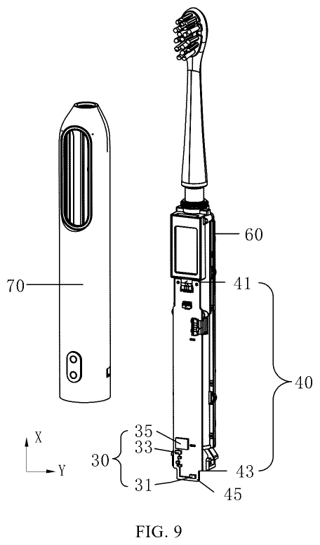

In some embodiments, as shown in FIGS. 9 and 10, the communication assembly 30 may further include a conductive piece 39, and the matching circuit 33 is electrically connected to the signal transceiver 31 and the main chip 35 via the conductive piece 39, enabling instruction signals sent from the main chip 35 to be transmitted to the signal transceiver 31 and/or the signals received by the signal transceiver 31 to be transmitted to the main chip 35 to enable the main chip 35 to control operations of other structures.

Compared to the second end 43 of the first circuit board 40, the first end 41 of the first circuit board 40 is disposed closer to the bottom cover 13. The signal transceiver 31 is disposed at the first end 41 of the first circuit board 40 and located closer to the bottom cover 13. When the signal transceiver 31 is disposed at the first end 41 of the first circuit board 40, a path along which the signals are sent inside the hand-held shell 10 is shorter. Therefore, the loss of the signals sent from the signal transceiver 31 is reduced. In addition, by arranging the signal transceiver 31 at the position closer to the bottom cover 13, the relative distance between the signal transceiver 31 and the external device capable of emitting the signals is reduced, so that the information conveyed by the signals received by the signal transceiver 31 is more complete. When the main chip 35, the matching circuit 33, and the signal transceiver 31 are all disposed on the first circuit board 40, the signal transceiver 31 and the matching circuit 33 are disposed closer to the first end 41 of the first circuit board 40 than the main chip 35 is. By arranging the matching circuit 33 between the main chip 35 and the signal transceiver 31, the mounting space occupied by the matching circuit 33 on the first circuit board 40 is minimized, so that electrical components on the first circuit board 40 are disposed more tightly, and the arrangement of the electrical components on the first circuit board 40 is more reasonable. In addition, since the signal transceiver 31 is disposed closer to the first end 41 of the first circuit board 40, the signal transceiving path of the signal transceiver 31 is prevented from being blocked when the user is holding the oral care device 100.

Furthermore, in some embodiments, when the signal transceiver 31 is disposed on the first circuit board 40, at least a portion of the first circuit board 40 on which the signal transceiver 31 is disposed extends into the space enclosed by the blocking portion 131 and the fastening portion 133, enabling at least a portion of the signal transceiver 31 to be located in the space enclosed by the blocking portion 131 and the fastening portion 133. When the signal transceiver 31 is disposed on the second circuit board 37, at least a portion of the second circuit board 37 on which the signal transceiver 31 is disposed extends into the space enclosed by the blocking portion 131 and the fastening portion 133, enabling at least a portion of the signal transceiver 31 to be located in the space enclosed by the blocking portion 131 and the fastening portion 133. Since the signals sent from the signal transceiver 31 can be transmitted to the exterior by passing through the blocking portion 131 and the fastening portion 133 respectively, when the portion of the signal transceiver 31 disposed on the first circuit board 40 at least partially extends into the blocking portion 131, the signal transceiver 31 is enabled to be located closer to the bottom cover 13. In this way, the efficiency of the signal transmission is improved, and the loss of the signals is reduced.

In some embodiments, the first circuit board 40 further includes a protruding portion 43, the protruding portion 43 is a portion of the first circuit board 40 extending in the first direction X towards the bottom cover 13. The protruding portion 43 protrudes towards the bottom cover 13 with respect to the movement assembly 60, i.e., the protruding portion 43 and the movement assembly 60 are staggered from each other in the second direction Y and do not overlap with each other. The signal transceiver 31 is disposed on the protruding portion 43. Compared to the case in which the first circuit board does not include the protruding portion 43, the signal transceiver 31 on the protruding portion 43 is staggered from the movement assembly 60, so that the signal transceiving range of the signal transceiver 31 partially avoids the movement assembly 60. On the one hand, since a movement made of metal is disposed inside the movement assembly 60, the signal transceiver 31 is staggered with the movement assembly 60, which prevents the movement assembly 60 from blocking the signal transmission path of the signal transceiver 31 for receiving the signals and/or sending the signals. On the other hand, the protruding portion 43 extending towards the bottom cover 13 is further configured to enable the signal transceiver 31 disposed on the protruding portion 43 to be closer to the bottom cover 13 to improve the signal transmission efficiency.

In some embodiments, the inner liner 70 is integrally molded with the hand-held portion 1 and is disposed inside the hand-held portion 11. In other embodiments, the inner liner 70 is molded separately and is then mounted inside of the hand-held portion 11.

In some embodiments, the bottom cover 13 is connected to the inner liner 70, and the bottom cover 13 and the inner liner 70 may be made of the same material or different materials. The bottom cover 13 and the inner liner 70 may be integrally molded to be a one-piece structure or separately molded. When the bottom cover 13 and the inner liner 70 are separately molded, the bottom cover 13 and the inner liner 70 are fixedly connected such as connected by hot-melt or by glues. Alternatively, the bottom cover 13 is detachably connected to the inner liner 70, such as connected by threads, or by snapping structures, or by bolts, which are not limited herein. In other embodiments, the bottom cover 13 is connected to the hand-held portion 11. In one example, the fastening portion 133 of the bottom cover 13 extends into the hand-held portion 11 and is connected to both the hand-held portion 11 and the inner liner 90. In another example, the fastening portion 133 of the bottom cover 13 is only connected to the hand-held portion 11 and is separated from the inner liner 70.

In summary, in the oral care device 100 of the present disclosure, the signal transceiver 31 is disposed on the one side close to the bottom cover 13 that is non-metallic, which prevents the hand-held portion 11 that is metallic from affecting the signal transceiving function of the antenna, ensuring the signal transmission quality and the signal strength. Further, the signal transceiver 31 is disposed corresponding to the bottom cover 13, which further ensures that at least part of the signal transceiving region of the signal transceiver 31 is located within the range of the bottom cover 13.

The above are examples illustrated by referring to the accompanying drawings, and the first portion 100a that is metallic and the second portion 100b that is non-metallic are described by taking various examples. It should be understood that the embodiments do not limit the present disclosure. For example, in some cases, the portion of the hand-held portion 11 connected to the bottom cover 13 may be non-metallic, and the portion of the hand-held portion 11 not connected to the bottom cover 13 may be metallic. That is, the second portion 100b includes the bottom cover 13 and the portion of the hand-held portion 11 connected to the bottom cover 13.

In the description of the present disclosure, reference to the terms “some embodiments”, “in an example”, “exemplarily”, and so on, mean that specific features, structures, materials, or characteristics are included in at least one embodiment or example of the present disclosure. In this specification, schematic expressions of the above terms do not necessarily refer to one same embodiment or example. Moreover, the specific features, structures, materials, or characteristics described may be combined in any one or more of the embodiments or examples in any suitable manner.

What is claimed is:

1. An oral care device, comprising:
a first portion;
a second portion; and
a communication assembly;
wherein the first portion is metallic, the second portion is non-metallic and is connected to the first portion;
wherein the communication assembly is disposed inside the first portion, wherein the communication assembly comprises a signal transceiver, the signal transceiver is disposed corresponding to the second portion, the signal transceiver is configured to send signals to an exterior of the oral care device and/or to receive signals from the exterior of the oral care device; and the second portion allows the signals sent by the signal transceiver and/or the signals received by the signal transceiver to pass through.

2. The oral care device according to claim 1, wherein the first portion comprises a hand-held portion, and the hand-held portion is metallic; the second portion comprises a bottom cover, and the bottom cover is non-metallic; the bottom cover is connected to a bottom end of the hand-held portion, the bottom cover and hand-held portion cooperatively form a hand-held shell;
the bottom cover is configured to allow the signals sent by the signal transceiver and/or the signals received by the signal transceiver to pass through.

3. The oral care device according to claim 1, wherein a distance between the signal transceiver and the second portion is less than a wavelength of the signals sent by the signal transceiver and/or a wavelength of the signals received by the signal transceiver.

4. The oral care device according to claim 2, wherein the oral care device further comprises a first circuit board disposed inside the hand-held shell, the communication assembly is electrically connected to the first circuit board;
the first circuit board comprises a first end and a second end opposite to the first end in a length direction of the hand-held shell; the first end of the first circuit board is disposed closer to the bottom cover than the second end of the first circuit board; the signal transceiver is mounted at the first end of the first circuit board.

5. The oral care device according to claim 4, wherein the oral care device further comprises a movement assembly disposed inside the hand-held shell;
the first end of the first circuit board defines a protruding portion, the protruding portion protrudes towards the bottom cover with respect to the movement assembly in a direction of a center axis of the hand-held shell, and the signal transceiver is disposed on the protruding portion.

6. The oral care device according to claim 4, wherein the oral care device further comprises a first circuit board disposed inside the hand-held shell, the communication assembly is electrically connected to the first circuit board;
the bottom cover comprises a blocking portion and a fastening portion extending from the blocking portion, the blocking portion is configured to seal an opening at a bottom end of the hand-held portion, the fastening portion extends to an interior of the hand-held portion and is connected to the hand-held portion, the signal transceiver is disposed on the first circuit board and at least partially extends into a space enclosed by the blocking portion and the fastening portion.

7. The oral care device according to claim 2, wherein the oral care device further comprises a first circuit board disposed inside the hand-held shell, the communication assembly is electrically connected to the first circuit board;
the communication assembly further comprises: a second circuit board, wherein the signal transceiver is disposed on the second circuit board, the signal transceiver is electrically connected to the first circuit board via the second circuit board and a conductive piece; and
the bottom cover comprises a blocking portion and a fastening portion extending from the blocking portion, the blocking portion is configured to block an opening at a bottom end of the hand-held portion, the fastening portion extends to an interior of the hand-held portion and is connected to the hand-held portion, the signal transceiver is disposed on the second circuit board and at least partially extends into a space enclosed by the blocking portion and the fastening portion.

8. The oral care device according to claim 2, wherein the signal transceiver is disposed on the bottom cover; or
the signal transceiver extends to reach the bottom cover.

9. The oral care device according to claim 2, wherein the oral care device further comprises a first circuit board disposed inside the hand-held shell, the communication assembly is electrically connected to the first circuit board;
the communication assembly further comprises a matching circuit and a main chip; wherein the matching circuit is disposed on the first circuit board, the main chip is disposed on the first circuit board and is spaced apart from the signal transceiver, and the main chip is electrically connected to the signal transceiver via the matching circuit.

10. The oral care device according to claim 9, wherein the first circuit board comprises a first end and a second end opposite to the first end in a length direction of the hand-held shell, the first end of the first circuit board is disposed closer to the bottom cover than the second end of the first circuit board, and the signal transceiver is disposed closer to the first end of the first circuit board than the main chip.

11. The oral care device according to claim 1, wherein the first portion comprises a hand-held shell, hand-held shell is metallic, the second portion comprises a panel, the panel is non-metallic, the hand-held shell defines a receiving cavity and a through hole communicated to the receiving cavity; the panel is mounted to the hand-held shell and covers the through hole; the panel is configured to allow the signals sent by the signal transceiver and/or the signals received by the signal transceiver to pass through.

12. The oral care device according to claim 11, wherein the panel is mounted on a first side of the hand-held shell, the oral care device further comprises a first circuit board, and the signal transceiver is disposed on one side of the first circuit board facing the panel.

13. The oral care device according to claim 12, wherein the oral care device further comprises a functional element, the functional element is received in the receiving cavity and faces the panel; the functional element is electrically connected to the first circuit board, and the signal transceiver is disposed within a predetermined distance from the functional element.

14. The oral care device according to claim 13, wherein the functional element comprises at least one of a button, an indicator, and a display;
wherein the button is provided, the button is received in the receiving cavity and is electrically connected to the first circuit board, wherein the panel comprises a pressing portion, the button faces the pressing portion, a distance between the signal transceiver and the button in a length direction of the hand-held shell is less than a first predetermined distance;
wherein when the indicator is provided, the indicator is received in the receiving cavity and is electrically connected to the first circuit board, wherein the panel comprises a light-transmitting portion; the indicator faces the light-transmitting portion; light emitted by the indicator is allowed to transmit to an exterior of the hand-held shell through the light-transmitting portion, a distance between the signal transceiver and the indicator in the length direction of the hand-held shell is less than a second predetermined distance;
wherein when the display is provided, the display is received in the receiving cavity and is electrically connected to the first circuit board, wherein the panel the light-transmitting portion, the display faces the light-transmitting portion, the display is configured to display an image through the light-transmitting portion towards the exterior of the hand-held shell; a distance between the signal transceiver and the display in the length direction of the hand-held shell is less than a third predetermined distance.

15. The oral care device according to claim 13, wherein, the functional element is spaced apart from the panel in a direction perpendicular to a length direction of the hand-held shell.

16. The oral care device according to claim 11, wherein the panel allows light to pass through and is non-transparent; or
the panel comprises a first region and a second region, the signal transceiver faces the first region, the oral care device further comprises a functional element, the functional element faces the second region, the first region does not allow the light to pass through, the second region allows the light to pass through.

17. The oral care device according to claim 1, wherein the oral care device further comprises a first circuit board and a functional element, the functional element is disposed on the first circuit board; the communication assembly comprises the signal transceiver, a matching circuit, and a main chip;
wherein the signal transceiver is disposed on the first circuit board and is spaced apart from the functional element;
wherein the matching circuit is disposed on the first circuit board;
wherein the main chip is disposed on the first circuit board and is spaced apart from the functional element and the signal transceiver, the main chip is electrically connected to the functional element, and the main chip is electrically connected to the signal transceiver via the matching circuit;
wherein the first circuit board comprises a first end and a second end opposite to the first end, the first end of the first circuit board is closer to the bottom of the handle shell than the second end of the first circuit board; and the signal transceiver, the functional element, and the matching circuit are disposed closer to the second end of the first circuit board than the main chip.

18. The oral care device according to claim 11, wherein the hand-held shell comprises a first side and a second side, the panel is mounted corresponding to the second side of the hand-held shell, the signal transceiver faces the panel, and the oral care device further comprises a first circuit board and a movement assembly;
wherein the first circuit board is mounted corresponding to the first side of the hand-held shell, the signal transceiver is electrically connected to the first circuit board, the movement assembly is received in the receiving cavity, the signal transceiver is fixed to the movement assembly, and an signal end of the signal transceiver faces the panel.

19. The oral care device according to claim 11, wherein the hand-held shell comprises a first side and a second side, the panel is mounted corresponding to the second side of the hand-held shell, the signal transceiver faces the panel, the oral care device further comprises a first circuit board mounted corresponding to the first side of the hand-held shell, and the signal transceiver is electrically connected to the first circuit board;
wherein the communication assembly further comprises a second circuit board disposed on the second side of the hand-held shell, the signal transceiver is disposed on the second circuit board, and the signal transceiver is electrically connected to the first circuit board through the second circuit board and a conductive piece.

20. The oral care device according to claim 11, wherein the oral care device further comprises an inner liner, the inner liner is received in the receiving cavity and is connected to the hand-held shell, and a support plate is disposed at a position of the inner liner corresponding to the through hole, and the panel is mounted on the support plate; or
the oral care device further comprises the inner liner and a movement assembly, the inner liner is received in the receiving cavity and is connected to the hand-held shell, and the inner liner comprises a connection portion; the movement assembly is disposed inside the inner liner, a mating portion is disposed on the movement assembly, the connection portion is slidably mating with the mating portion to connect the movement assembly to the inner liner.
